(19) United States
(12) Patent Application Publication
(10) Pub. No.: US 2024/0105056 A1
(43) Pub. Date: Mar. 28, 2024

(54) ELECTRONIC DEVICE, VEHICLE, DISPLAY CONTROL METHOD, AND STORAGE MEDIUM

(71) Applicant: ISUZU MOTORS LIMITED, Tokyo (JP)

(72) Inventor: Takashi KAWANO, Fujisawa-shi (JP)

(21) Appl. No.: 18/468,875

(22) Filed: Sep. 18, 2023

(30) Foreign Application Priority Data
Sep. 26, 2022 (JP) 2022-152863

(51) Int. Cl. G08G 1/0967; B60K 35/00; G06V 10/764; G06V 20/56; G06V 20/58

(52) U.S. Cl. CPC G08G 1/096766; B60K 35/00; G06V 10/764; G06V 20/582; G06V 20/588; B60K 2370/152; B60K 2370/168; G06V 2201/08

(57) ABSTRACT

An electronic device includes an acquisition part that acquires a first speed limit indicated by a sign included in a captured image generated by a camera included in a vehicle and a position of the vehicle, an identification part that identifies a second speed limit corresponding to the vehicle according to the first speed limit and a country or region identified from the position of the vehicle, and a display control part that causes a display part to display the second speed limit.

### CROSS-REFERENCE TO RELATED APPLICATIONS

The present application claims priority to Japanese Patent Applications number 2022-152863, filed on Sep. 26, 2022, contents of which are incorporated herein by reference in its entirety.

### BACKGROUND OF THE INVENTION

The present disclosure relates to an electronic device that identifies a speed limit of a vehicle, a vehicle, a display control method, and a storage medium. A conventional vehicle speed limit display apparatus acquires speed limit information on the basis of captured image data generated by an imaging means and displays the speed limit information. Further, when the vehicle speed limit display apparatus cannot acquire the speed limit information from the captured image data, the vehicle speed limit display apparatus identifies a country on the basis of at least one of the captured image data or position information and estimates a speed limit corresponding to the identified country (for example, refer to Japanese Unexamined Patent Application Publication No. 2017-215902).

The conventional vehicle speed limit display apparatus can have a driver grasp the speed limit of the country in which a vehicle travels when the speed limit cannot be acquired from a captured image or the like. On the other hand, when a speed limit can be acquired from the captured image or the like, the conventional vehicle speed limit display apparatus recognizes the speed limit as the speed limit for the vehicle. However, when a speed limit sign for a passenger car is captured while traveling on a road in which a speed limit of a large vehicle such as a truck is lower than a speed limit of a passenger car, there is a problem that a driver of a large vehicle may grasp the speed limit of the passenger car which is higher than the speed limit of the large vehicle.

### BRIEF SUMMARY OF THE INVENTION

The present disclosure focuses on this point, and its object is to have a driver grasp a speed limit suitable for a vehicle.

An electronic device according to a first aspect of the present disclosure includes: an acquisition part that acquires a first speed limit indicated by a sign included in a captured image generated by a camera included in a vehicle and a position of the vehicle; and an identification part that identifies a second speed limit corresponding to the vehicle according to the first speed limit and a country or region identified from the position of the vehicle; and a display control part that causes a display part to display the second speed limit.

A vehicle according to a second aspect of the present disclosure includes the above mentioned electronic device, and a camera that generates a captured image.

A display control method according to a third aspect of the present disclosure is executed by a processor and including: acquiring a first speed limit indicated by a sign included in a captured image generated by a camera included in a vehicle and a position of the vehicle; identifying a second speed limit corresponding to the vehicle according to the first speed limit and a country or region identified from the position of the vehicle; and causing a display part to display the second speed limit.

A storage medium according to a fourth aspect of the present disclosure stores a program for causing a processor to execute: acquiring a first speed limit indicated by a sign included in a captured image generated by a camera included in a vehicle and a position of the vehicle; identifying a second speed limit corresponding to the vehicle according to the first speed limit and a country or region identified from the position of the vehicle; and causing a display part to display the second speed limit.

### BRIEF DESCRIPTION OF THE DRAWINGS

FIG. 1 is a diagram illustrating an outline of a vehicle S according to the present embodiment.

FIG. 2 shows an example of vehicle speed limits stored in a storage 32.

FIG. 3 shows an example of vehicle speed limits stored in the storage 32.

FIG. 4 shows an example of a processing sequence in an electronic device 3.

FIG. 5 shows an example of information about traffic regulations stored in the storage 32.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### <Outline of a Vehicle S>

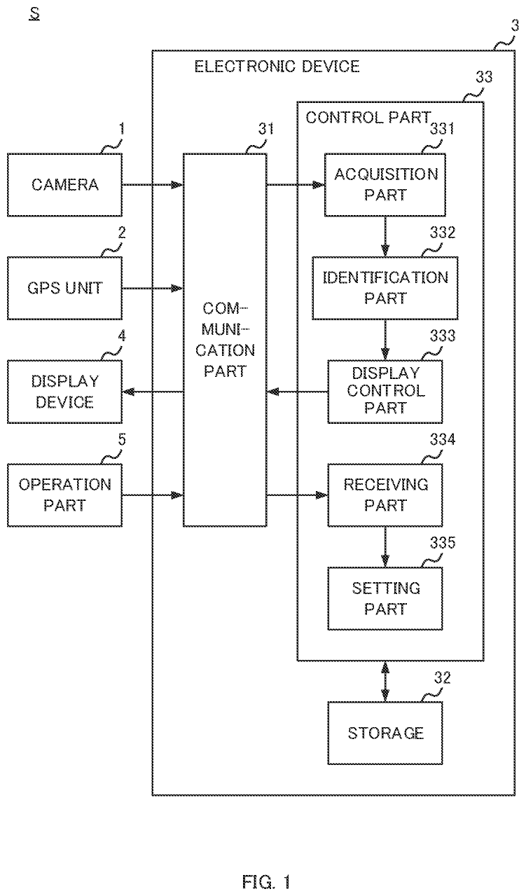

FIG. 1 is a diagram illustrating an outline of a vehicle S according to the present embodiment. The vehicle S shown in FIG. 1 includes a camera 1, a global positioning system (GPS) unit 2, an electronic device 3, a display part 4, and an operation part 5. The vehicle S is a large vehicle such as a truck, for example. The vehicle S has a function of identifying a speed limit of a large vehicle on the basis of a speed limit of a passenger car indicated by a sign installed on a road and a position of the vehicle S and causing the display part 4, such as a display, to display the identified speed limit of the large vehicle.

The camera 1 extracts the sign indicating the speed limit of the passenger car from a captured image generated by capturing a region ahead in the vehicle S's traveling direction, and transmits the speed limit indicated by the extracted sign to the electronic device 3.

The GPS unit 2 receives radio waves transmitted from GPS satellites, and calculates the latitude and longitude on the basis of information included in the received radio waves. The GPS unit 2 transmits the calculated latitude and longitude to the electronic device 3 as position information of the vehicle S.

In roads of some countries and regions, a speed limit sign for large vehicles may not be installed even though a speed limit sign for passenger cars is installed. There is a case where the speed limit of a large vehicle is different from the speed limit of a passenger car (for example, the speed limit of the large vehicle may be lower than the speed limit of the passenger car). In such a case, a driver of a large vehicle needs to recognize a speed limit of the large vehicle that he/she drives, on the basis of the speed limit indicated by the speed limit sign for a passenger car. However, in a conventional sign recognition apparatus that extracts speed limit information from a speed limit sign included in a captured image captured by an imaging device, the speed limit of the captured sign would be displayed. Therefore, the driver of the large vehicle may not appropriately grasp the speed limit of the vehicle that he/she drives because the driver of the large vehicle cannot determine whether or not the displayed speed limit is the speed limit of the large vehicle.

In view of the above problem, the electronic device 3 executes a process of identifying a speed limit of the vehicle S (large vehicle) corresponding to a speed limit of a passenger car in a country or region on the basis of (i) said country or region based on the position information acquired from the GPS unit 2 and (ii) the speed limit of the passenger car acquired from the camera 1. The electronic device 3 causes the display part 4 to display the identified speed limit of the vehicle S. The electronic device 3 may be in any form. The electronic device 3 may have a housing including electronic components, or may be a printed circuit board on which the electronic components are mounted.

The display part 4 is a display that displays a speed, fuel level, time, temperature, or the like, and acquires and displays data indicating a speed limit corresponding to the vehicle S from the electronic device 3. The display part 4 is provided on an instrument panel of the vehicle S, and it may be provided on an information terminal used by a driver.

The operation part 5 is a button or a touch panel for the driver to operate, and is a steering switch, for example. The operation part 5 receives an operation for setting the speed limit identified by the electronic device 3 to the maximum speed of the vehicle S from the driver, for example.

As described above, since the electronic device 3 identifies the speed limit of the vehicle S corresponding to the speed limit of the passenger car in the country or region where the vehicle S is located, the driver can grasp the speed limit even when the sign indicating the speed limit of the large vehicle such as the vehicle S is not installed. Hereinafter, the configuration and operation of the electronic device 3 will be described in detail.

### <Configuration of the Electronic Device 3>

The electronic device 3 includes a communication part 31, a storage 32, and a control part 33. The control part 33 includes an acquisition part 331, an identification part 332, a display control part 333, a receiving part 334, and a setting part 335. It is assumed that the electronic device 3 is a control board on which a processor and a storage medium described later are mounted.

The communication part 31 includes a communication device for transmitting and receiving information via a network or a digital signal transmission bus. The communication device is a controller area network (CAN) controller, for example.

The storage 32 includes a storage medium such as a read only memory (ROM), a random access memory (RAM), a hard disk drive (HDD), or a solid state drive (SSD). The storage 32 stores a program executed by the control part 33. The storage 32 identifies the speed limit corresponding to the vehicle S, and stores various types of information to be displayed on the display part 4. For example, the storage 32 stores map information including position information indicating a position of a road and a position of a country or region.

The control part 33 is an arithmetic unit (processor) such as a central processing unit (CPU) or an electronic control unit (ECU), for example. The control part 33 functions as the acquisition part 331, the identification part 332, the display control part 333, the receiving part 334, and the setting part 335 by executing the program stored in the storage 32. The control part 33 may be configured with a combination of a plurality of processors and electronic components. The configuration of each unit implemented by the control part 33 will be described below.

The acquisition part 331 acquires (i) a first speed limit (hereinafter referred to as a “sign speed limit”) indicated by the sign included in the captured image generated by the camera 1 included in the vehicle S and (ii) a position of the vehicle S. The sign speed limit is a speed limit corresponding to a small vehicle such as a passenger car. For example, the acquisition part 331 acquires the sign speed limit from the camera 1, and stores the sign speed limit in the storage 32 in association with the acquired time. The acquisition part 331 acquires position information indicating the position of the vehicle S from the GPS unit 2, and stores the position information in the storage 32 in association with the acquired time.

Further, the acquisition part 331 acquires vehicle body information of the vehicle S. The vehicle body information includes at least one of (i) vehicle classification information indicating vehicle classifications in which at least one of a weight of the vehicle S or a passenger capacity of the vehicle S differs, or (ii) tire classification information in which the size and type of tires fitted to the vehicle S are different. Since the vehicle body information is acquired by the acquisition part 331, it is possible to identify which vehicle classification among a plurality of vehicle classifications corresponding to the large vehicles the vehicle S corresponds to. For example, the acquisition part 331 acquires the vehicle body information stored in the storage 32, and notifies the identification part 332 about the vehicle body information.

The identification part 332 identifies a second speed limit (hereinafter referred to as a “vehicle speed limit”) corresponding to the vehicle S according to the sign speed limit and a country or region identified from the position of the vehicle S. For example, the identification part 332 identifies the country or region where the vehicle S is located on the basis of the map information stored in the storage 32 and the position of the vehicle S acquired by the acquisition part 331. Then, the identification part 332 identifies a vehicle speed limit by acquiring the vehicle speed limit corresponding to the sign speed limit and the country or region identified from the position of the vehicle S from the storage 32.

The identification part 332 may identify the country or region where the vehicle S is located by referencing area information stored in the storage 32 in advance. The area information is information set by the driver operating the operation part 5 from among information indicating a plurality of countries or regions displayed on the display part 4.

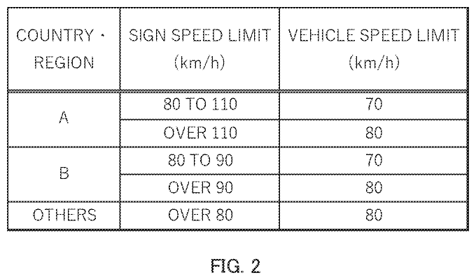

FIG. 2 shows an example of vehicle speed limits stored in the storage 32. As shown in FIG. 2, the storage 32 stores a vehicle speed limit in association with a plurality of ranges of the sign speed limit associated with a plurality of countries or regions.

For example, the identification part 332 acquires a sign speed limit “90 km/h” from the acquisition part 331, and identifies a country/region “A” on the basis of the position information acquired by the acquisition part 331. Then, the identification part 332 identifies a vehicle speed limit “70 km/h” corresponding to the country/region “A” and a sign speed limit “80 to 110 km/h” by referencing “vehicle speed limit” shown in FIG. 2. Since the identification part 332 operates in this manner, it is possible to identify the speed limit corresponding to the vehicle S in the country or region where the vehicle S is located.

Further, the identification part 332 may identify the vehicle speed limit according to the sign speed limit, the country or region identified from the position of the vehicle S, and the vehicle body information of the vehicle S. For example, the identification part 332 identifies one vehicle speed limit corresponding to (i) the identified country or region, (ii) the sign speed limit acquired by the acquisition part 331, and (iii) the vehicle classification information or the tire classification information included in the vehicle body information acquired by the acquisition part 331, among the plurality of vehicle speed limits stored in the storage 32 in association with (i) countries or regions, (ii) ranges of the sign speed limit including sign speed limits, and (iii) the vehicle classification information or the tire classification information.

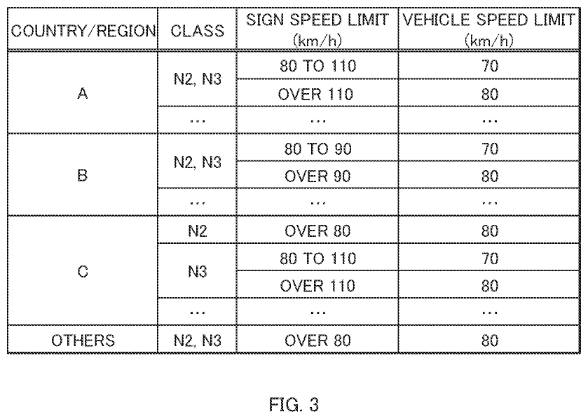

FIG. 3 shows an example of vehicle speed limits stored in the storage 32. As shown in FIG. 3, the storage 32 stores, for each of a plurality of countries or regions, (i) a plurality of pieces of vehicle classification information in which at least one of a weight or a passenger capacity of the vehicle S corresponds to a plurality of different classifications, (ii) a range of the sign speed limit, and (iii) a vehicle speed limit, in association with each other. The vehicle classification information is a class “N2” when the gross vehicle weight is greater than 3.5 t and equal to or less than 12.0 t, and is a class “N3” when the gross vehicle weight is greater than 12.0 t, for example.

For example, the identification part 332 acquires the vehicle body information including the vehicle classification information indicating the sign speed limit “90 km/h” and the class “N3” from the acquisition part 331, and identifies a country/region “C” on the basis of the position information acquired by the acquisition part 331. Then, by referencing “vehicle speed limit” shown in FIG. 3, the identification part 332 identifies a vehicle speed limit “70 km/h” corresponding to the country/region “C”, the class “N3”, and a sign speed limit “80 to 110 km/h”. Since the identification part 332 operates in this manner, it is possible to identify the speed limit corresponding to the vehicle classification of the vehicle S in the country or region where the vehicle S is located.

Further, the identification part 332 may identify the vehicle speed limit further on the basis of the tire classification information in which the size and type of tires fitted to the vehicle S are different. The tire classification information is a class “C2” in the case of tires for a small commercial vehicle, and is a class “C3” in the case of tires for a large commercial vehicle, for example. For example, the identification part 332 acquires the sign speed limit and the vehicle body information including the tire classification information from the acquisition part 331, and identifies a country or region on the basis of the position information acquired by the acquisition part 331. By referencing the storage 32, the identification part 332 identifies a vehicle speed limit corresponding to the country or region, the classification indicated by the tire classification information, and the sign speed limit.

The display control part 333 causes the display part 4 to display the vehicle speed limit identified by the identification part 332. For example, the display control part 333 causes the display part 4 to display an image indicating a sign corresponding to the vehicle speed limit. Further, the display control part 333 may further display a predetermined notification when the speed limit to be displayed on the display part 4 is the vehicle speed limit identified on the basis of the sign speed limit and the position information and is different from the sign speed limit. The predetermined notification is a message or an image indicating that the image displayed on the display part 4 is an image corresponding to the vehicle speed limit, for example. By doing this, the driver can recognize whether the displayed speed limit is the sign speed limit or the vehicle speed limit.

Further, the display control part 333 may cause the display part 4 to display a message for inquiring whether or not to set the vehicle speed limit to the maximum speed of the vehicle S. For example, when the identification part 332 identifies the vehicle speed limit, the display control part 333 causes the display part 4 to display a message “Do you wish to change the speed limit?” or “Do you wish to change the maximum speed?” together with the image indicating the sign corresponding to the vehicle speed limit.

The receiving part 334 receives an instruction to set the vehicle speed limit to the maximum speed of the vehicle S from the operation part 5. For example, after the display control part 333 displays a message indicating whether or not to set the vehicle speed limit to the maximum speed of the vehicle S on the display part 4, the receiving part 334 receives the instruction given by the driver operating the operation part 5.

The setting part 335 sets the vehicle speed limit to the maximum speed of the vehicle S on the basis of the instruction received by the receiving part 334. For example, in a case where the receiving part 334 receives an instruction to set the vehicle speed limit to the maximum speed of the vehicle S, the setting part 335 overwrites the maximum speed stored in the storage 32 with the vehicle speed limit. When the receiving part 334 receives an instruction not to set the vehicle speed limit to the maximum speed of the vehicle S, the setting part 335 does not overwrite the maximum speed stored in the storage 32 with the vehicle speed limit.

### <Processing Sequence in the Electronic Device 3>

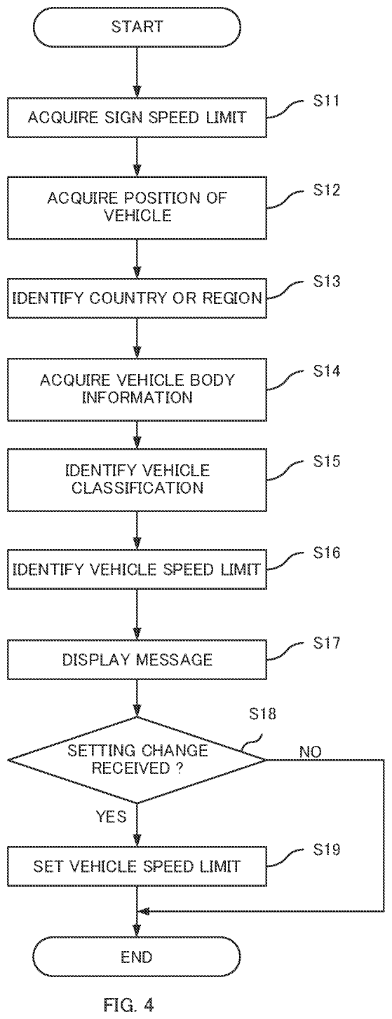

FIG. 4 shows an example of a processing sequence in the electronic device 3. The processing sequence shown in FIG. 4 shows, as an example, an operation from acquiring the sign speed limit until changing the setting of the maximum speed of the vehicle S. This processing sequence is described as being executed in response to acquisition of the sign speed limit, and it is assumed that an acquisition process of the captured image by the camera 1 and a recognition process of the sign speed limit are repeatedly executed after the vehicle S is activated (ignition on).

The acquisition part 331 acquires a speed limit (sign speed limit) indicated by a sign included in a captured image generated by the camera 1 (S11), and acquires position information indicating a position of the vehicle S from the GPS unit 2 (S12). The identification part 332 identifies a country or region where the vehicle S is located on the basis of map information stored in the storage 32 and the position information of the vehicle S acquired by the acquisition part 331 (S13).

The acquisition part 331 acquires vehicle body information of the vehicle S by referencing the storage 32 (S14). The identification part 332 identifies a vehicle classification indicated by vehicle classification information included in the vehicle body information acquired by the acquisition part 331 (S15). Then, the identification part 332 identifies one range including the sign speed limit acquired by the acquisition part 331 among a plurality of sign speed limit ranges corresponding to the identified country or region and the vehicle classification information, and identifies a vehicle speed limit corresponding to the identified range (S16).

The display control part 333 causes the display part 4 to display an image corresponding to the sign indicating the vehicle speed limit identified by the identification part 332, and causes the display part 4 to display a message for inquiring whether or not to set the vehicle speed limit to the maximum speed of the vehicle S (S17). If an operation of not setting the vehicle speed limit to the maximum speed of the vehicle S is received from the operation part 5 (NO in S18), the receiving part 334 ends the process. On the other hand, if the receiving part 334 receives an operation of setting the vehicle speed limit to the maximum speed of the vehicle S from the operation part 5 (YES in S18), the vehicle speed limit is set to the maximum speed by overwriting the maximum speed stored in the storage 32 with the vehicle speed limit (S19).

### Modified Example

In the above description, the operation in which the electronic device 3 identifies the vehicle speed limit corresponding to the vehicle S on the basis of the sign speed limit, the country or region in which the vehicle S is located, and the vehicle classification of the vehicle S is exemplified, but the present disclosure is not limited thereto. The electronic device 3 may identify traffic regulations other than the speed limit in a country or region by identifying the country or region where the vehicle S is located, for example. Examples of the traffic regulations other than the speed limit are regulations concerning a lane in which a vehicle travels (right-hand traffic or left-hand traffic) and regulations concerning a priority vehicle at a roundabout/traffic circle (priority is given to a vehicle in a roundabout or to a vehicle outside the roundabout).

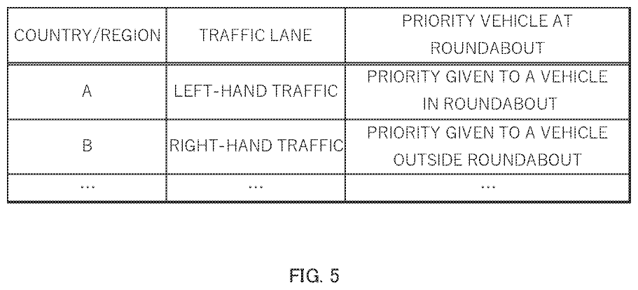

FIG. 5 shows an example of information about traffic regulations stored in the storage 32. In FIG. 5, “traffic lane” and “priority vehicle at roundabout” corresponding to a country or region are shown. For example, the identification part 332 identifies a country or region where the vehicle S is located on the basis of the position information of the vehicle S acquired by the acquisition part 331 and the map information stored in the storage 32. Then, the identification part 332 identifies a lane in which the vehicle S should travel and the vehicle to be given priority at the roundabout by referencing the “travel lane” and the “priority vehicle at roundabout” shown in FIG. 5. The display control part 333 causes the display part 4 to display the lane in which the vehicle S should travel and the vehicle to be given priority at the roundabout that are identified by the identification part 332. Since the electronic device 3 operates in the manner described above, it is possible to display traffic regulations suitable for the position of the vehicle S even when the country or region where the vehicle S is located changes during traveling.

### <Effect of the Electronic Device 3>

As described above, the electronic device 3 includes the acquisition part 331 that acquires the sign speed limit (first speed limit) indicated by the sign included in the captured image generated by the camera 1 included in the vehicle S and the position of the vehicle S, the identification part 332 that identifies the vehicle speed limit (second speed limit) corresponding to the vehicle S according to the sign speed limit and the country or region identified from the position of the vehicle S, and the display control part 333 that causes the display part 4 to display the vehicle speed limit.

By configuring the electronic device 3 in this manner, it is possible to identify the vehicle speed limit of the large vehicle and to display the vehicle speed limit of the large vehicle on the display part 4, on the basis of (i) the country or region in which the vehicle S, which is the large vehicle, travels and (ii) the sign speed limit of the passenger car indicated by the sign. As a result, even on a road where a sign indicating the speed limit of the large vehicle is not installed, the driver can grasp the vehicle speed limit suitable for that road and corresponding to the country or region where his/her vehicle travels.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. An electronic device comprising:
an acquisition part that acquires a first speed limit indicated by a sign included in a captured image generated by a camera included in a vehicle and a position of the vehicle; and
an identification part that identifies a second speed limit corresponding to the vehicle according to the first speed limit and a country or region identified from the position of the vehicle; and
a display control part that causes a display part to display the second speed limit.

2. The electronic device according to claim 1, further comprising:
a storage that stores the second speed limit in association with a plurality of ranges of the first speed limit associated with a plurality of countries or regions, wherein the identification part identifies the second speed limit by acquiring, from the storage, the second speed limit corresponding to the first speed limit and the country or region identified from the position of the vehicle.

3. The electronic device according to claim 1, wherein
the acquisition part acquires vehicle body information of the vehicle, and
the identification part identifies the second speed limit according to the first speed limit, a country or a region identified from the position of the vehicle, and the vehicle body information of the vehicle.

4. The electronic device according to claim 3 further comprising:
a storage that stores, for each of a plurality of countries or regions, (i) a plurality of pieces of vehicle classification information in which at least one of a weight or a passenger capacity of the vehicle corresponds to a plurality of different classifications, (ii) a range of the first speed limit, and (iii) the second speed limit, in association with each other.

5. The electronic device according to claim 4, wherein
the identification part identifies one second speed limit corresponding to the vehicle classification information included in the vehicle body information acquired by the acquisition part among the plurality of second speed limits stored in the storage.

6. The electronic device according to claim 3, wherein
the vehicle body information includes tire classification information in which the size and type of tires fitted to the vehicle are different, and
the identification part identifies the second speed limit further on the basis of the tire classification information.

7. The electronic device according to claim 1, wherein
the display control part causes the display part to display a message for inquiring whether or not to set the second speed limit to the maximum speed of the vehicle.

8. The electronic device according to claim 1, further comprising:
a receiving part that receives an instruction to set the second speed limit to the maximum speed of the vehicle; and
a setting part that sets the second speed limit to the maximum speed of the vehicle on the basis of the instruction received by the receiving part.

9. The electronic device according to claim 1, wherein
the identification part identifies, by referencing a traffic lane and a priority vehicle at a roundabout corresponding to a country or region stored in the storage, the traffic lane and the priority vehicle at the roundabout corresponding to a country or region identified on the basis of position information of the vehicle, and
the display control part causes the display part to display the traffic lane and the priority vehicle at the roundabout that are identified by the identification part.

10. A vehicle comprising:
the electronic device according to claim 1, and
a camera that generates a captured image.

11. A display control method executed by a processor and comprising:
acquiring a first speed limit indicated by a sign included in a captured image generated by a camera included in a vehicle and a position of the vehicle;
identifying a second speed limit corresponding to the vehicle according to the first speed limit and a country or region identified from the position of the vehicle; and
causing a display part to display the second speed limit.

12. A storage medium storing a program for causing a processor to execute:
acquiring a first speed limit indicated by a sign included in a captured image generated by a camera included in a vehicle and a position of the vehicle;
identifying a second speed limit corresponding to the vehicle according to the first speed limit and a country or region identified from the position of the vehicle; and
causing a display part to display the second speed limit.
